(19) United States
(12) Patent Application Publication
(10) Pub. No.: US 2026/0110421 A1
(43) Pub. Date: Apr. 23, 2026

(54) AMBIENT LIGHT EMITTING LIGHT DEVICE

(71) Applicant: ANTARES ILUMINACIÓN, S.A.U., VALENCIA (ES)

(72) Inventor: Pablo ILLUECA BEL, VALENCIA (ES)

(21) Appl. No.: 19/347,214

(22) Filed: Oct. 1, 2025

(30) Foreign Application Priority Data
Oct. 17, 2024 (ES) U202431925

(51) Int. Cl. F21V 17/10; F21S 4/20; F21S 8/04; F21V 3/04; F21V 15/015; F21V 23/00; F21V 23/02; F21V 23/04; F21V 23/06; F21Y 115/10; H05B 47/19

(52) U.S. Cl. CPC F21V 17/10; F21S 4/20; F21S 8/04; F21V 3/049; F21V 15/015; F21V 23/006; F21V 23/009; F21V 23/023; F21V 23/0435; F21V 23/06; H05B 47/19; F21Y 2115/10

(57) ABSTRACT

A lighting device for emitting ambient light in a controlled and programmed manner, includes a longitudinal body and a longitudinal cover; wherein the longitudinal cover is press-fitted to the top of the longitudinal body; and wherein the longitudinal body has a side wall on each side, wherein a lighting strip is attached to the outer face of each side wall and is arranged longitudinally along the entire wall of the longitudinal body; a first diffuser is attached to the outer face of each side wall and is superimposed on the light strip along the entire wall of the longitudinal body; and a second diffuser is attached to the outer face of each side wall and is superimposed on the first diffuser along the entire wall of the longitudinal body.

### CROSS-REFERENCE TO RELATED APPLICATIONS AND PRIORITY

This patent application claims priority from Spanish Patent Application No. U202431925 filed Oct. 17, 2024. This patent application is herein incorporated by reference in its entirety.

### DESCRIPTION

### Field of the Invention

The present disclosure includes a lighting device that projects ambient light, wherein the device is based on a bar that is fitted with a light strip and diffusers superimposed on the strip, being arranged at least on each of the sides of the bar, which allow the aforementioned projection of ambient light in a controlled and programmed manner.

This invention falls within different types of lighting equipment and systems, and more specifically, within devices for projecting ambient light.

### State of the Art

It is known within this industrial sector that ambient light is a type of light that provides basic visibility in any space that does not produce shadows or glare, i.e., it is a type of lighting that serves to see a space as a whole based on dim lighting. For this reason, this type of light is generally projected by luminaires with points of light or spotlights, such as ceiling lamps, floor lamps or table lamps.

In this sense, ambient light is mainly used to create different atmospheres and environments; but, while all types of light serve to create environments in one way or another, aspects such as the colour of the light or the design of the luminaires are more important when it comes to ambient light. In this regard, it is also known that known ambient light lighting devices may comprise projectors that are programmable to emit different colours or intensities.

With these aspects in mind, in order to illuminate large rooms, a number of different lighting devices are currently installed, with one or more points of light, which are previously programmed. This means that current installations are designed for small rooms or that the projection of ambient light is directed only in a specific area of a large room, given that illuminating an entire large room involves the high cost of installing a large number of lighting devices, each with its own assembly.

In this context, the applicant is not aware of any ambient light lighting device that can, on its own, cover large rooms and which can project, in a controlled manner, different types of ambient light, such as accent light, wall washer light, batwing light, or that can even be programmed to emit task lighting.

In order to overcome the problems and limitations existing in the state of the art, the present invention is based on a bar consisting of linear profiles that allow a greater amount of ambient light to be emitted than a point device and that allow, for example, light to be projected onto an entire wall, and wherein, unlike a lamp for example, different bars can be joined together linearly to cover large rooms. This configuration allows the bar to be fitted with a light strip and diffusers superimposed on the strip, all of which are arranged on each of its sides to allow, in a controlled and programmed manner, the aforementioned projection of ambient light, being able, on the one hand, to control the colour or intensity of the light, and wherein the diffusers in turn allow the light to be dimmed so that no shadows or glare are produced.

The applicant is not aware of any lighting device for emitting ambient light that is similar to and as advantageous as the one described and claimed below.

### DESCRIPTION OF THE INVENTION

The invention is a novel type of lighting device for emitting ambient light that solves, in its different embodiments, the problems and limitations present in the state of the art.

The device object of the present invention consists of a lighting device comprising a longitudinal body and a longitudinal cover; wherein the cover is press-fitted to the top of the body; and wherein
the body comprises a side wall on each side of the body, wherein a light strip is attached to the outer face of each side wall and is arranged longitudinally along the entire wall of the body
a first diffuser that is attached to the outer face of each side wall and is superimposed on the light strip along the entire wall of the body;
a second diffuser that is attached to the outer face of each side wall and is superimposed on the first diffuser along the entire wall of the body;
an open channel arranged in the top of the body, wherein said channel comprises an electronic board and a power supply module comprising an electrical connection to a power supply; wherein the electronic board is of the PCB type and is in connection with the light strips; and wherein the power supply module is in connection with the electronic board and the light strips; and wherein the attachment of the cover to the body closes the channel and protects the aforementioned components.

Going into greater detail, in a preferred embodiment of the invention, each side wall of the body, specifically on its outer face, has a longitudinal groove generated by two T-shaped projections, one upper projection and one lower projection, wherein the light strip arranged longitudinally along the entire wall of the body is attached in the aforementioned groove. Said projections, in turn, allow the coupling of the first diffuser arranged longitudinally along the entire wall of the body, with a preferably curved cross-section and smooth faces, and wherein this first diffuser is superimposed on the strip, and wherein the first diffuser comprises indentations at its ends where the projections are fitted.

The outer face of the side wall of each side of the body, in a preferred embodiment of the invention, further comprises another set of overhangs, one above the upper projection and one below the lower projection, for the coupling of the second diffuser arranged longitudinally along the entire wall of the body and superimposed on the first diffuser, for which the second diffuser comprises slots at its ends where the overhangs are fitted. In one possible embodiment of the invention, the second diffuser has a curved cross-section, wherein the outer face is ribbed and the inner face is smooth. In another possible embodiment of the invention, the second diffuser has a C-shaped cross-section with straight edges, wherein the outer face is ribbed and the inner face is smooth. One of the particularities of the invention lies in the fact that the ribbed surface of the outer face of the second diffuser makes it possible to improve the diffused projection of the light emitted, given that the configuration of said ribs, whether by dimensions, number and/or separation, makes it possible to adjust and adapt the orientation of the different light beams of the light emitted by the light strip.

The top of the body comprises an open longitudinal channel, wherein the closure of the cover with the body generates a longitudinal compartment, and wherein said channel has an electronic board of the PCB type in connection with the light strips and a power supply module that powers both the PCT board and the light strips. The power supply module is connected to a power supply. This can be either by a direct connection to a transformer arranged in a housing on the cover, which allows the bar to be attached directly to the ceiling of the room, or by connecting cables to the power supply integrated in ceiling hangers, which allow the bar to hang from the ceiling of the room.

The invention has the particularity that the electronic board can be programmed so that each light strip emits light independently, i.e., the device can be programmed so that the light strip on one side emits light at a different intensity than the one on the other side, so as to improve the illumination of a wall area. For this purpose, the PCB board may comprise a wireless connection module for wireless connection to an external electronic device, preferably having a Bluetooth-type connection, and wherein a user can manage said lighting in a particular manner.

In one possible embodiment of the invention, the bottom of the body is closed with a base wall, generating an internal channel that can be used as a conduit. In this sense, in one possible embodiment of the invention, the base wall may comprise a light strip and in turn two superimposed diffusers attached to said base wall in the same way as previously indicated, the light strip being in connection with the PCB board.

Furthermore, the invention has the particularity that each bar-shaped device can be linearly connected to other bars by connecting covers arranged at their ends. These connecting covers can have multiple forms, such as closed covers that allow a lighting system with a straight longitudinal shape, either with the bars directly attached to the ceiling or hanging from the ceiling; or they can be covers with a joint that allows a non-straight longitudinal shape to be generated, either with the bars directly attached to the ceiling or hanging from the ceiling; or even the union of a horizontal bar hanging from the ceiling with a vertical bar attached to the ceiling. This versatility, which makes it possible to overcome the limitations existing in known installations, is possible because each lighting device comprises a PCB board independent from the rest that gives it autonomy with respect to any other bar in the system. Therefore, the connectors do not require electrical connection elements, and the different bars can be programmed so that as a whole a particular ambient light is emitted for each room. This versatility improves the projection of ambient light in large rooms, with the advantage, compared to known systems, of not having to carry out multiple installations of spotlight devices.

In one preferred embodiment of the invention, the light strip is of the LED type, although it is not intended to be limiting and, therefore, the strip can be of any other commercial type.

The material of the diffusers may be polycarbonate, polypropylene, acrylic material or any other commercially available diffuser.

Likewise, the materials of the rest of the different elements of the device can be any resistant material such as plastic, polymer, metal or a mixture of several of them.

It should be noted that, throughout the description and claims, the term “comprises” and its variants are not intended to exclude other technical features or additional elements.

### BRIEF DESCRIPTION OF THE FIGURES

In order to complete the description and to help make the features of the invention more readily understandable, a set of figures and drawings is presented wherein the following is represented by way of illustration and not limitation:

FIG. 1 shows a schematic view of an exploded section of an embodiment of the device object of the present invention.

FIG. 2 shows a cross-sectional view of an embodiment of the invention wherein the bar is directly attached to the ceiling of a room and wherein the second diffuser has curved faces.

FIG. 3 shows a cross-sectional view of an embodiment of the invention wherein the lighting device is hanging from the ceiling of a room and wherein the second diffuser has C-shaped faces with straight edges.

FIG. 4 shows a perspective view of an embodiment of the invention wherein the lighting device is hanging from the ceiling, wherein the second diffuser has curved faces, wherein the body is open at the bottom and wherein there is an unclosed end.

FIG. 5 shows a perspective view of a detail of an embodiment of the invention wherein the lighting device is directly attached to the ceiling, wherein the second diffuser has curved faces, wherein the body is closed at the bottom and wherein its end is closed with a cover.

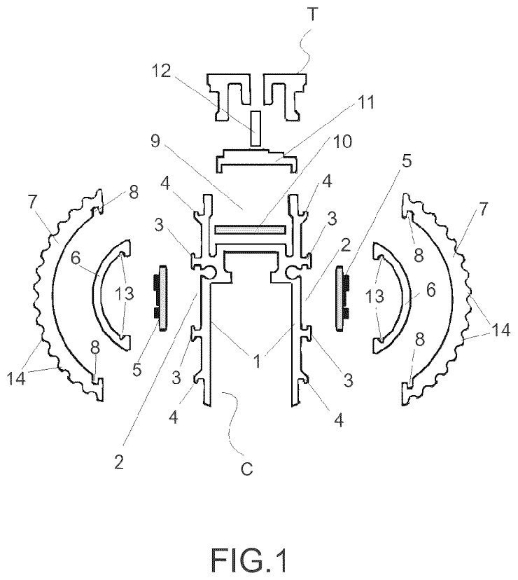

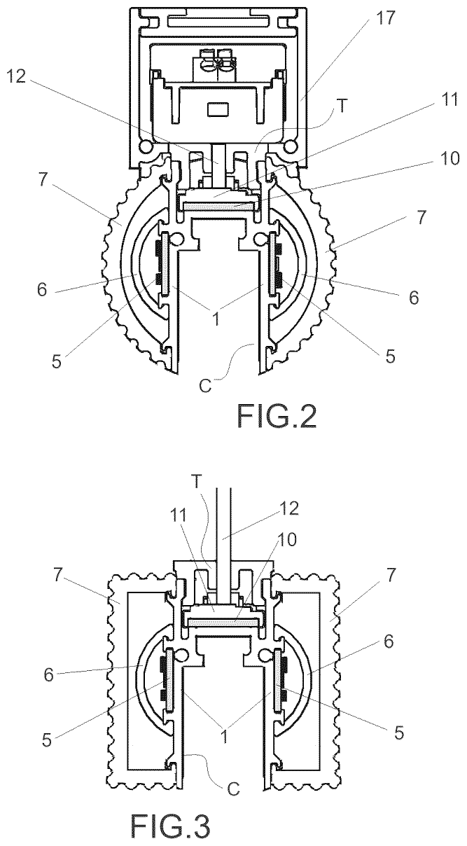

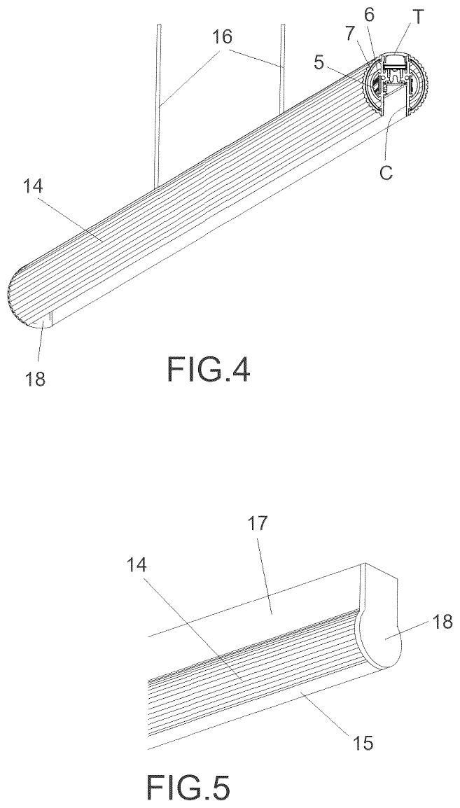

### DETAILED DESCRIPTION OF EMBODIMENTS OF THE INVENTION

In a general embodiment, the device for projecting ambient light of the present invention has the particularity of consisting of a bar-shaped device comprising a longitudinal body (C) and a longitudinal cover (T); wherein the cover is press-fitted to the top of the body; and wherein
the body comprises a side wall (1) on each side of the body, wherein a lighting strip (5) is attached to the outer face of each side wall and is arranged longitudinally along the entire wall of the body
a first diffuser (6) that is attached to the outer face of each side wall (1) and is superimposed on the lighting strip (5) along the entire wall of the body;
a second diffuser (7) that is attached to the outer face of each side wall (1) and is superimposed on the first diffuser (6) along the entire wall of the body;
an open channel (9) arranged in the top of the body, wherein said channel comprises an electronic board (10) and a power supply module (11) comprising an electrical connection (12) to a power supply; wherein the electronic board (10) is in connection with the light strips; and wherein the power supply module is in connection with the electronic board (10) and the light strips (5); and wherein the attachment of the cover (T) to the body (C) closes the channel (9).

In one embodiment of the invention, and going into greater detail, the device comprises:
a longitudinal groove (2) arranged in the outer face of each side wall (1) and which is generated by two T-shaped projections (3), one upper projection and one lower projection; and wherein the side wall comprises a set of overhangs (4), one above the upper projection and one below the lower projection;
a light strip (5), which is attached in the groove (2) and arranged longitudinally along the entire wall of the body
a first diffuser (6) with a curved cross-section, comprising indentations (13) at the ends where the projections (3) are fitted, and wherein the first diffuser (6) is attached to the side wall (1), superimposed on the light strip (5) and arranged longitudinally along the entire wall of the body;
a second diffuser (7) with a cross-section comprising slots (8) at the ends where the overhangs (4) are fitted and wherein the second diffuser (7) is attached to the side wall (1), superimposed on the first diffuser (6) and arranged longitudinally along the entire wall of the body;
an open channel (9) arranged in the top of the body, wherein said channel has an electronic board (10) and a power supply module (11) comprising an electrical connection (12) to a power supply; wherein the electronic board (10) is in connection with the light strips; and wherein the power supply module is in connection with the electronic board (10) and the light strips (5)
and wherein the closure of the cover (T) with the body (C) closes the channel (9) and generates a longitudinal closed compartment that protects the electronic board (10) and the supply module.

In one embodiment of the invention, the first diffuser (6) has a curved cross-section.

In one embodiment of the invention, the surface of the faces of the first diffuser (6) is smooth.

In one embodiment of the invention, the second diffuser has a curved cross-section, wherein the outer face is ribbed (14) and the inner face is smooth.

In one embodiment of the invention, the second diffuser has a C-shaped cross-section with straight edges, where the outer face is ribbed (14) and the inner face is smooth.

In one possible embodiment of the invention, the body (C) is closed with a base wall (15).

In one possible embodiment of the invention, the device is hanging from the ceiling, so that the electrical connection of the power supply module to a power supply is integrated into the hangers (16) of the lighting device.

In one possible embodiment of the invention, the device is directly attached to the ceiling, so that the electrical connection of the power supply module to a power supply consists of a direct connection to a transformer arranged in a housing (17) on the cover of the body, and wherein the housing is directly attached to the ceiling.

In one possible embodiment of the invention, the device may comprise connecting covers (18) arranged at the ends that allow the bar to be linearly connected to other bars.

1. A lighting device for emitting ambient light comprising:
a longitudinal body and a longitudinal cover, wherein the longitudinal cover is press-fitted to a top of the longitudinal body, and wherein the longitudinal body comprises a side wall on each side of the longitudinal body, wherein a lighting strip is attached to an outer face of each side wall and is arranged longitudinally along an entire wall of the longitudinal body;
a first diffuser attached to the outer face of each side wall and superimposed on the lighting strip along the entire wall of the longitudinal body;
a second diffuser attached to the outer face of each side wall and superimposed on the first diffuser along the entire wall of the longitudinal body; and
an open channel arranged on top of the longitudinal body, wherein said open channel comprises an electronic board and a power supply module comprising an electrical connection to a power supply; wherein the electronic board is connected to the lighting strip; and wherein the power supply module is connected to the electronic board and the lighting strip; and wherein attachment of the longitudinal cover to the longitudinal body closes the channel.

2. The lighting device, according to claim 1, wherein the outer face of each side wall comprises a longitudinal groove formed by two T-shaped projections, one upper projection and one lower projection; and comprises a set of overhangs, one overhang above the upper projection and one overhang below the lower projection.

3. The lighting device, according to claim 2, wherein the lighting strip is attached in the longitudinal groove.

4. The lighting device, according to claim 2, wherein a cross-section of the first diffuser comprises indentations at ends of the first diffuser fittable to the two T-shaped projections of the side wall.

5. The lighting device, according to claim 2, wherein a cross-section of the second diffuser comprises slots at ends of the second diffuser fittable to the overhangs of the side wall.

6. The lighting device, according to claim 1, wherein a cross-section of the first diffuser is curved.

7. The lighting device, according to claim 1, wherein a surface of a plurality of faces of the first diffuser is smooth.

8. The lighting device, according to claim 1, wherein a cross-section of the second diffuser is curved.

9. The lighting device, according to claim 1, wherein a cross-section of the second diffuser is C-shaped with straight edges.

10. The lighting device, according to claim 1, wherein a surface of the outer face of each side wall of the second diffuser is ribbed and a surface of an inner face of each side wall is smooth.

11. The lighting device, according to claim 1, wherein the electronic board is of a PCB type.

12. The lighting device, according to claim 1, wherein the lighting strip is of an LED type.

13. The lighting device, according to claim 1, wherein the longitudinal body is closed at a bottom with a base wall.

14. The lighting device, according to claim 1, wherein the electronic board comprises a wireless connection module for wireless connection to external electronic devices.

15. The lighting device, according to claim 14, wherein the wireless connection module is of a Bluetooth type.
